(19) United States
(12) Patent Application Publication
(10) Pub. No.: US 2015/0125263 A1
(43) Pub. Date: May 7, 2015

(54) FLINGER OIL SEAL AND TURBOCHARGER INCORPORATING THE SAME

(71) Applicant: BorgWarner Inc., Auburn Hills, MI (US)

(72) Inventor: David G. Grabowska, Asheville, NC (US)

(21) Appl. No.: 14/399,985

(22) PCT Filed: May 1, 2013
(86) PCT No.: PCT/US2013/038968

§ 371 Date: Nov. 10, 2014

Related U.S. Application Data
(60) Provisional application No. 61/647,784, filed on May 16, 2012.

(51) Int. Cl. F04D 29/051; F04D 17/10; F02M 25/07

(52) U.S. Cl. CPC F04D 29/051; F02M 25/0706; F04D 17/10
USPC 415/104

(57) ABSTRACT

A compressor oil seal comprising a thrust bearing (59) adapted for insertion into a turbocharger housing cavity (33), concentric with the turbocharger's compressor wheel shaft (11). An insert (360) is adapted for insertion into the cavity (33) adjacent the thrust bearing (59), wherein the thrust bearing (59) and insert (360) are configured to provide an oil drain cavity (35) therebetween. The oil seal also includes an oil flinger (340) that includes a flinger flange (382) and a sleeve portion (383) extending therefrom. The flinger flange (382) extends between the thrust bearing (59) and the insert (360). A plurality of spiral vane segments (74) are circumferentially spaced about the flinger flange (382). Each spiral vane segment (74) extends arcuately from a first end (372) to a second end (373). The spiral vane segments (74) are disposed between the flinger flange (382) and the insert (360). The spiral vane segments (74) may extend into a recess (363) formed into the insert (360), and the recess (363) may include at least one discharge port (370).

### BACKGROUND

Turbochargers are a type of forced induction system. Turbochargers deliver air, at greater density than would be possible in a normally aspirated configuration. The greater air density allows more fuel to be combusted, thus boosting the engine's horsepower without significantly increasing engine weight. A smaller turbocharged engine, replacing a normally aspirated engine of a larger physical size, will reduce the mass of the engine and can reduce the aerodynamic frontal area of the vehicle.

With reference to FIG. 1, turbochargers use the exhaust flow from the engine exhaust manifold to drive a turbine wheel 10. Once the exhaust gas has passed through the turbine wheel and the turbine wheel has extracted energy from the exhaust gas, the spent exhaust gas exits a turbine housing (not shown). The energy extracted by the turbine wheel is translated to a rotating motion which then drives a compressor wheel 32. The compressor wheel draws air into the turbocharger, compresses this air and delivers it to the intake side of the engine. The rotating assembly consists of the following major components: turbine wheel 10, shaft 11 upon which the turbine wheel is mounted, compressor wheel 32, flinger 40, and thrust components. The shaft 11 rotates on a hydrodynamic bearing system 18 which is fed oil, typically supplied by the engine. The oil is delivered via an oil feed port 21 to feed both journal and thrust bearings. The thrust bearing 59 controls the axial position of the rotating assembly relative to the aerodynamic features in the turbine housing and compressor housing. In a manner somewhat similar to that of the journal bearings, the thrust loads are carried typically by ramped hydrodynamic bearings working in conjunction with complementary axially-facing rotating surfaces of a flinger 40. The turbocharger includes a housing 20 with a cavity 33. The thrust bearing 59 and insert 60 are disposed in the cavity and provide an oil drain cavity 35. Once used, the oil drains to the bearing housing and exits through an oil drain 22 fluidly connected to the engine crankcase.

Gas and oil passage from within a turbocharger bearing housing to the compressor or turbine stages of a turbocharger is not permitted by engine manufacturers as it contributes to emissions generation and can poison catalysts. Turbocharger manufacturers have been using seal rings, typically piston rings, to seal gases and oil from communicating between the bearing housing cavity and turbine, and/or compressor stages, since turbochargers were first in mass production in Diesel engines in the 1950s.

Seal means such as seal rings, sometimes also called piston rings, are commonly used within a turbocharger to create a seal between the static bearing housing and the dynamic rotating assembly (i.e., turbine wheel, compressor wheel, flinger, and shaft) to control the passage of oil and gas from the bearing housing to both compressor and turbine stages and vice versa.

With reference to FIG. 2, the typical seal ring (46, 47) has a rectangular cross section which is partially disposed in a groove in the flinger 40, providing partial sealing between the shaft and its bore. It is well known in the art that these seals suffer from at least some leakage depending on the conditions across the seal. The flinger 40 helps direct oil away from these seals. While existing flinger designs are effective in keeping oil away from the seal rings, there is still room for improvement as emission requirements become ever-stricter.

### SUMMARY

Provided herein is a compressor oil seal. In one exemplary embodiment, the oil seal comprises a thrust bearing adapted for insertion into a turbocharger housing cavity, concentric with the turbocharger's compressor wheel shaft. An insert is adapted for insertion into the cavity adjacent the thrust bearing, wherein the thrust bearing and insert are configured to provide an oil drain cavity therebetween. The oil seal also includes an oil flinger that includes a flinger flange and a sleeve portion extending therefrom. The flinger flange extends between the thrust bearing and the insert and the sleeve portion extends axially into an insert bore formed through a central portion of the insert.

In one aspect of the technology described herein, a plurality of spiral vane segments are circumferentially spaced about the flinger flange. Each spiral vane extends arcuately from a first end to a second end. The spiral vane segments are disposed between the flinger flange and the insert. The spiral vane segments may extend into a recess formed into the insert. The recess may include at least one discharge port.

Also contemplated herein is a turbocharger incorporating the disclosed compressor oil seal. In an embodiment, the turbocharger comprises a compressor wheel and a turbine wheel mounted on opposite ends of a shaft. The turbocharger includes a housing supporting the shaft and including a cavity formed adjacent the compressor wheel. A thrust bearing and an adjacent insert are disposed in the cavity. The turbocharger includes an oil flinger including a flinger flange and a sleeve portion extending therefrom. The flinger flange extends between the thrust bearing and the insert and the sleeve portion extends axially into an insert bore formed through a central portion of the insert. A plurality of spiral vane segments are circumferentially spaced about the flinger flange and are disposed on an axially facing surface of the flinger flange.

In one aspect of the disclosed technology, the spiral vane segments are located between the flinger flange and the thrust bearing. In another aspect of the technology, the spiral vane segments are located between the flinger flange and the insert. Each spiral vane extends arcuately from a first end to a second end, wherein the first end is located at a radius on the flinger flange that is smaller than a radius at which the second end is located. The flinger may also include a seal ring disposed in a groove formed around the sleeve portion.

These and other aspects of the flinger oil seal will be apparent after consideration of the Detailed Description and Figures herein. It is to be understood, however, that the scope of the invention shall be determined by the claims as issued and not by whether given subject matter addresses any or all issues noted in the background or includes any features or aspects recited in this summary.

### DRAWINGS

Non-limiting and non-exhaustive embodiments of the flinger oil seal, including the preferred embodiment, are described with reference to the following figures, wherein like reference numerals refer to like parts throughout the various views unless otherwise specified.

FIG. 1 is a side view in cross-section of a typical turbocharger;

FIG. 2 is an enlarged partial cross-section of a typical compressor end sealing package;

FIG. 3 is a partial cross-section of an flinger oil seal according to a first exemplary embodiment;

FIG. 4 is an end view in cross-section of the seal shown in FIG. 3 taken about line 4-4;

FIG. 5 is an enlarged partial cross-section of the flinger oil seal shown in FIGS. 3 and 4;

FIG. 6A is an enlarged partial cross-section view of a flinger ring shown in FIGS. 3-5;

FIG. 6B is an enlarged partial cross-section view of the flinger rings shown in FIG. 6A illustrating the oscillation of the flinger;

FIG. 7A is a partial cross-section of a flinger oil seal according to a second exemplary embodiment;

FIG. 7B is an end view in cross-section of the seal shown in FIG. 7A taken about line 7B-7B;

FIG. 8 is an end view in cross-section of a flinger oil seal according to a third exemplary embodiment;

FIG. 9A is an enlarged partial cross-section of the flinger oil seal shown in FIG. 8;

FIG. 9B is an end view in cross-section of the seal shown in FIG. 9A taken about line 9B-9B;

FIG. 10A is a cross-section view of a flinger oil seal according to a fourth exemplary embodiment;

FIG. 10B is an end view in cross-section of the seal shown in FIG. 10A taken about line 10B-10B;

FIG. 11A is a cross-section view of a spiral vane turbine shield according to a fifth exemplary embodiment; and

FIG. 11B is an end view of the spiral vane turbine shield shown in FIG. 11A.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense. It should be understood that not all of the components of a turbocharger are shown in the figures and that the present disclosure contemplates the use of various turbocharger components as are known in the art. Turbocharger construction is well understood in the art and a full description of every component of a turbocharger is not necessary to understand the technology of the present application, which is fully described and disclosed herein.

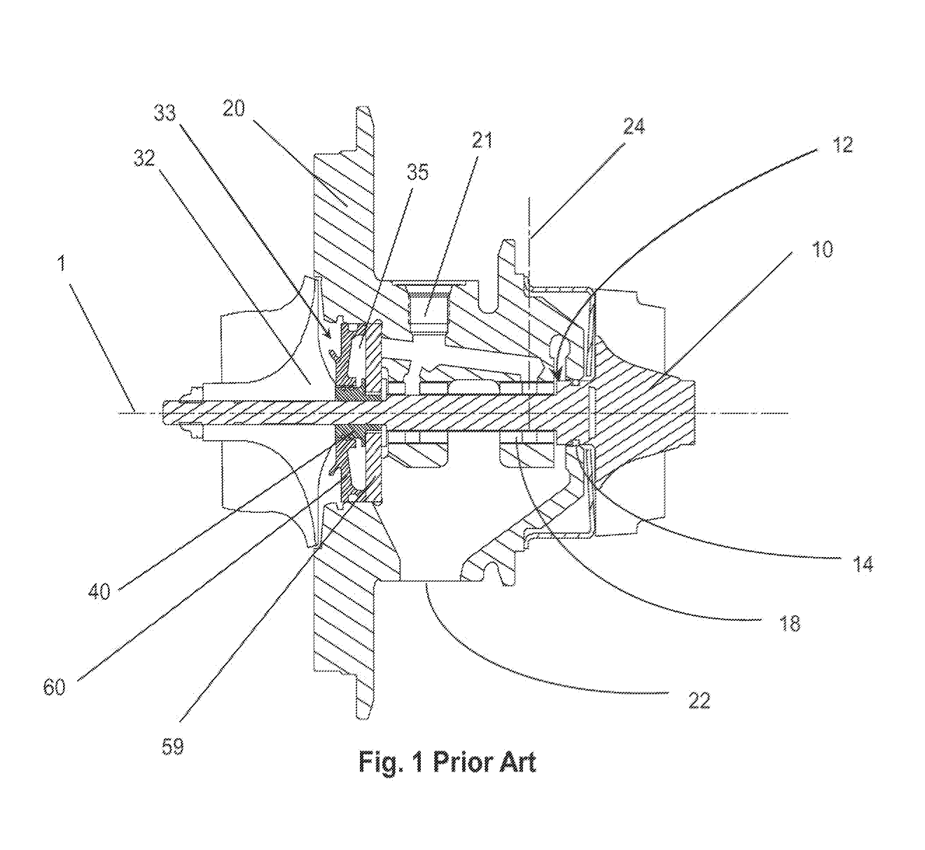

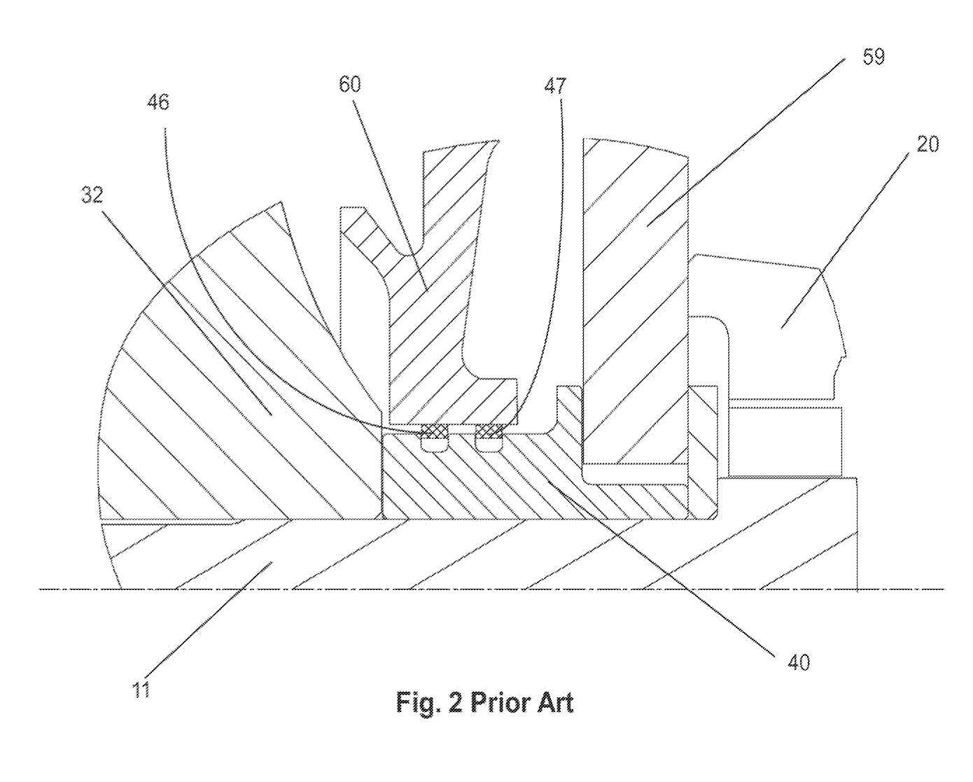

The shaft-and-wheel assembly does not rotate perfectly about the centerline of the bearing housing. Each end of the shaft-and-wheel (turbine-end and compressor-end) describes independent orbits, the loci of which are not necessarily on the centerline of the bearing housing. In addition to these orbits, it has been determined that the rotating assembly tilts about a point located at approximately the center of the turbine-end journal bearing. In other words, at the intersection of the turbocharger centerline 1 and the axial centerline 24 of the turbine-end journal bearing as depicted in FIG. 1. The tilt of the compressor-end rotating components about the tilt center causes the need for some (additional) radial and axial clearance between complementary components to limit the chance of contact.

Disclosed herein is an oil seal that makes use of the orbital motion of the rotating assembly. In one embodiment, for example, this is accomplished with a series of rings or vanes that are disposed on an axially facing surface of the flinger such that each vane is concentric with the flinger's geometric axis of rotation 1. The vanes rotate in a complementary coaxial groove or recess fabricated into an axially facing face of the insert. A series of discharge ports are formed in the rotating flinger that allow the egress of oil captured by the orbital rotation of the dynamic ring in the static groove thereby inhibiting said oil from migrating towards the seal rings.

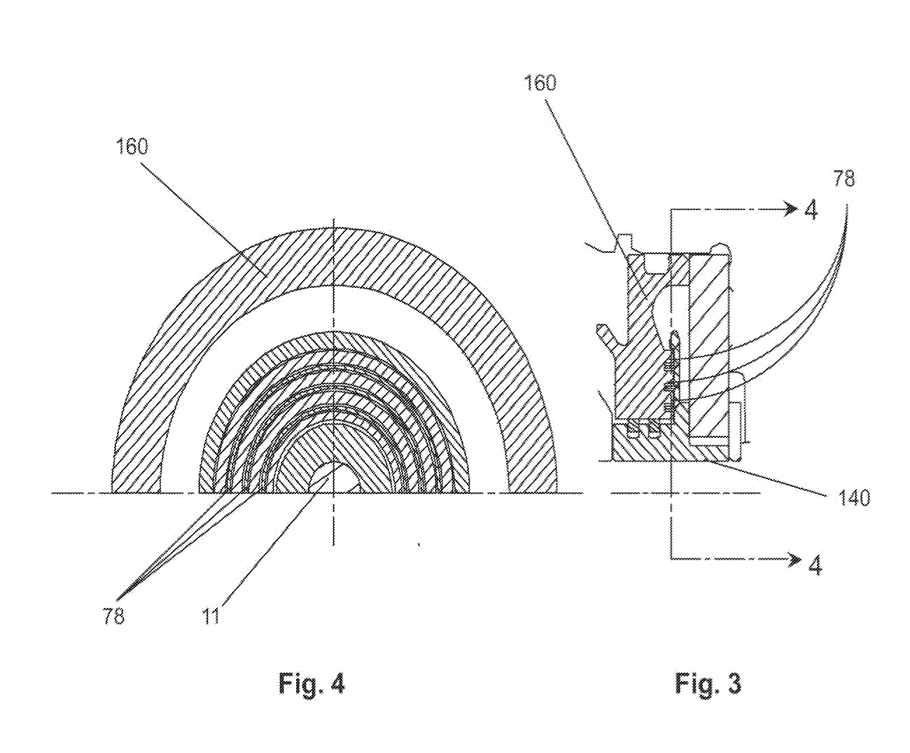

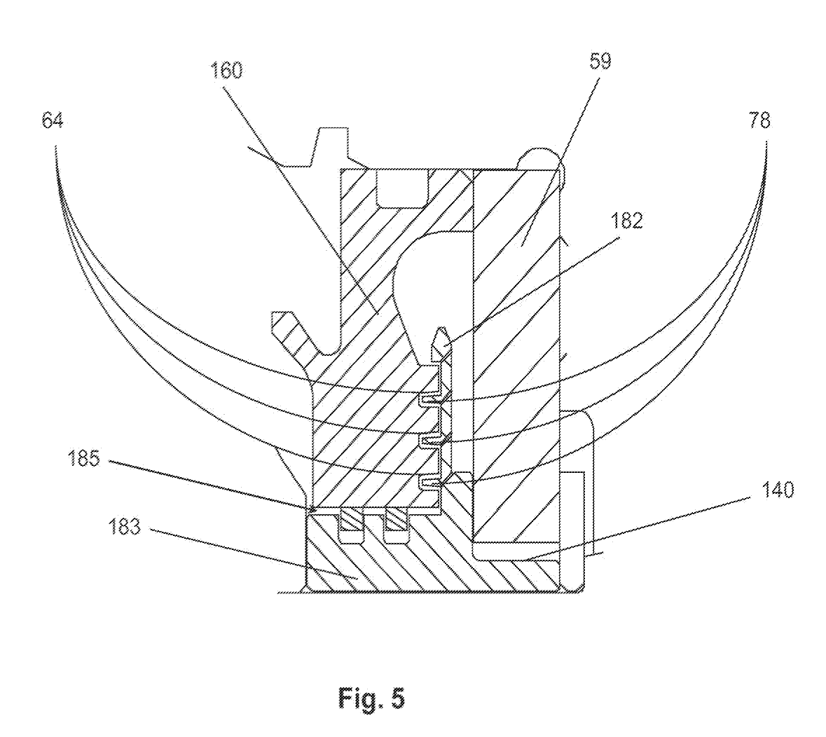

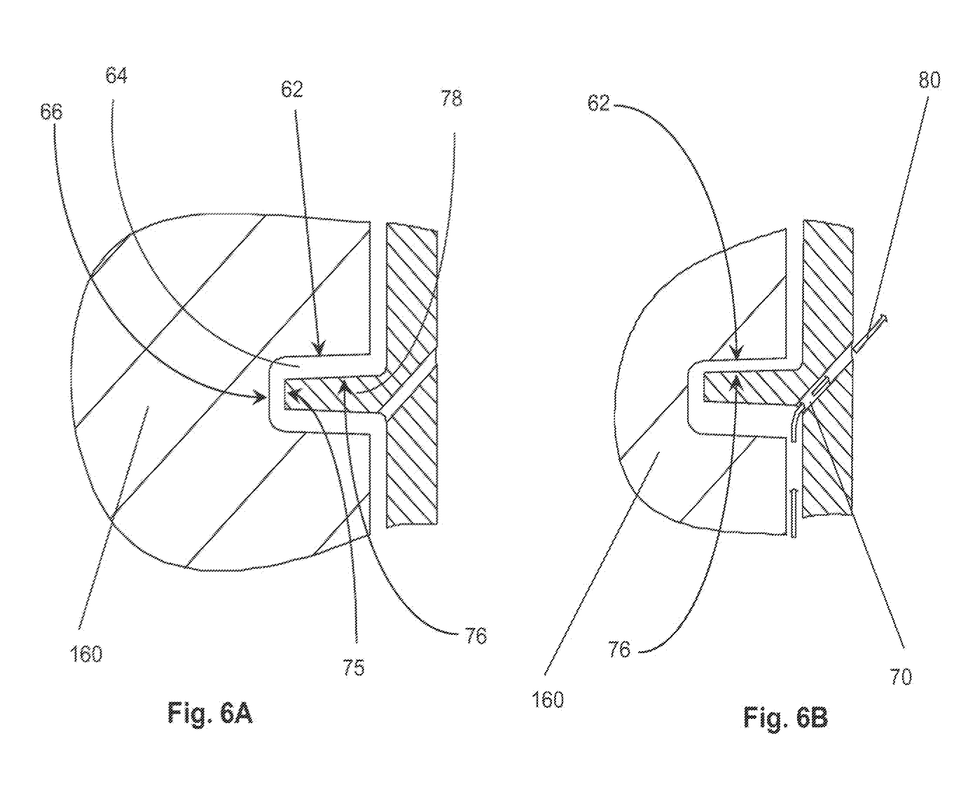

FIGS. 3-6B illustrate a flinger oil seal according to a first exemplary embodiment. The oil seal includes a flinger 140 and a corresponding insert 160. Flinger 140 includes a flinger flange 182 and a sleeve portion 183 extending therefrom. The flinger flange 182 extends between the thrust bearing 59 and the insert 160. The sleeve portion 183 extends axially into an insert bore 185 formed through a central portion of the insert 160. Flinger 140 includes a plurality of rings 78 disposed on flinger flange 182 that are concentric with shaft 11. With reference to FIG. 5, each ring 78 fits into a complementary groove 64 formed in insert 160. Each groove 64 includes radially facing surfaces 62 and an axially facing surface 66 (See FIGS. 6A and 6B). Each ring 78 includes an axially facing end face 75 and two radially facing side walls 76. Flinger 140 also includes oil discharge ports 70 extending from the inside corner of each ring 78. Discharge ports 70 fluidly couple the volume between the insert 160 and the flinger 140 with the open volume between the turbine side face of the flinger and the thrust bearing 59. Because the flinger oscillates while rotating, a pumping action is generated between the complementary surfaces of the rings 78 and the grooves 64 in which they reside, thereby forcing any oil which enters the volume between the flinger and the insert to be forced out through the plurality of oil discharge ports 70 and away from the seal rings 46, 47. Each oil discharge port 70 is angled towards the outer diameter of the flinger 140 causing centrifugal force to act on the oil 80 in the discharge port 70 which assists in purging the oil 80 out of the port.

Comparing FIGS. 6A and 6B, the oscillations about the turbine-end journal bearing causes the distance between the radially-facing surfaces 76 and the complementary radially-facing surfaces 62, to cyclically grow and shrink. To provide more clearance due to this mechanical action, and to assist in manufacturability, a taper can be formed onto the ring's radially facing surfaces 76. It is assumed that in the manufacturing process the rings 78 can be partially or fully “coined” into the flinger radially-facing surface. A similar taper may also be provided on the radially-facing sidewalls 62 of the grooves 64 in the insert.

While the rings 78 in the first embodiment are shown to circumscribe a complete circle (360°), the rings may be segmented thus forming individual vanes which can allow the oil, locally pressurized by the oscillating rotation of the vanes in the groove, to escape away from the seal rings more rapidly, thus improving the efficiency of the seal mechanism. Also, although the first embodiment is shown in the figures to have a plurality of rings and complementary insert grooves, a single ring and groove arrangement is contemplated. Furthermore, the rings and grooves may be switched between the insert and flinger. Specifically, the grooves may be formed into the flinger, and the rings may be disposed on the insert. In such a case, the oil discharge port would preferably still be in the dynamic component (i.e. flinger) so that the oil is centrifugally ejected from the system. Also, while the vanes are shown in the figures as being disposed between the insert and the flinger flange, the vanes may be disposed between the flinger flange and the thrust bearing.

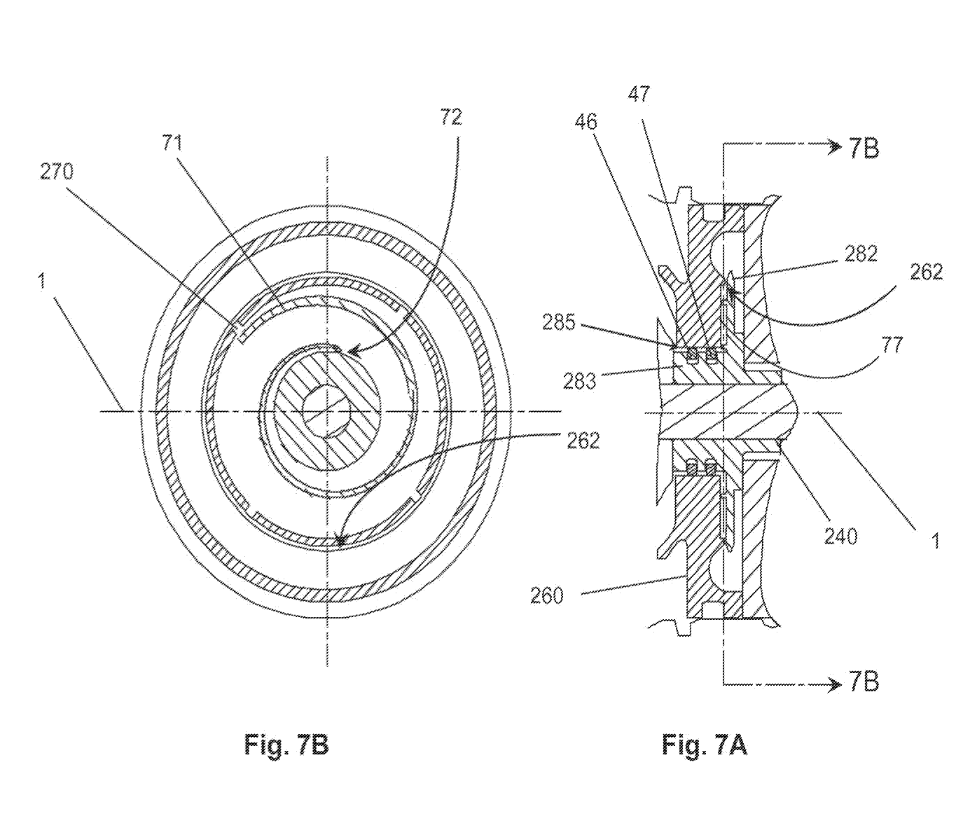

FIGS. 7A and 7B illustrate a flinger oil seal according to a second exemplary embodiment. In this embodiment, a spiral vane 71 is disposed on the flinger 240 and centered on the geometric axis of rotation 1 of the flinger 240. Flinger 240 includes a flinger flange 282 and a sleeve portion 283 extending therefrom. The flinger flange 282 extends between the thrust bearing 59 and the insert 260. The sleeve portion 283 extends axially into an insert bore 285 formed through a central portion of the insert 260. Spiral vane 71 fits into a single cylindrical concentric recess 77 formed in the insert 260. Rotation of the flinger 240 (clockwise in FIG. 7B) causes the leading edge 72 of the spiral vane 71 to divert the flow of oil, gas, or solids which have worked their way toward the seal rings (46, 47), onto the radially facing surface of rotating spiral vane 71, which then guides the flow of said unwanted oil, gas, or solids toward the radially facing inner lip 262 of the insert and out of the enclosure via the oil discharge ports 270 in the insert.

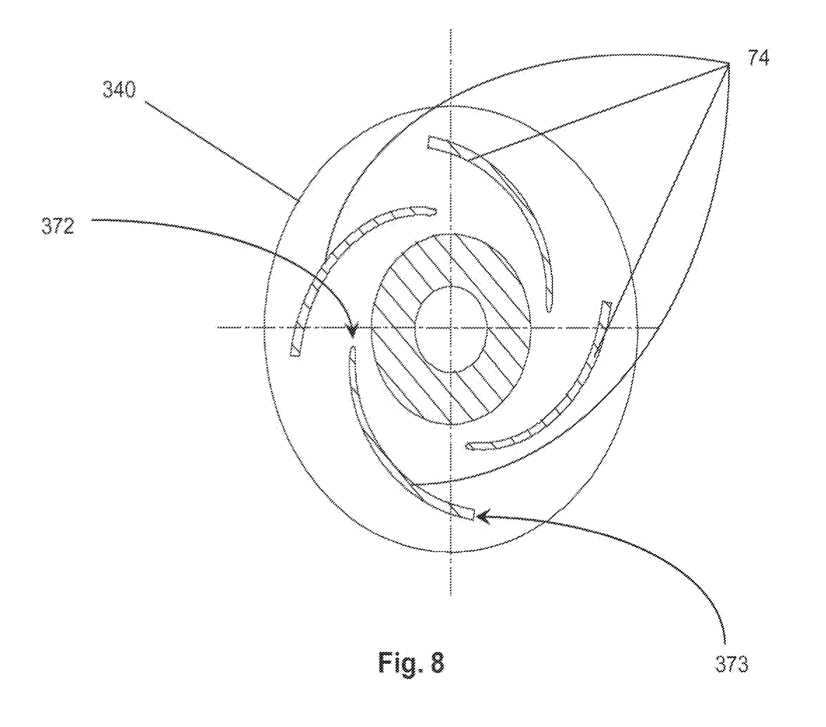

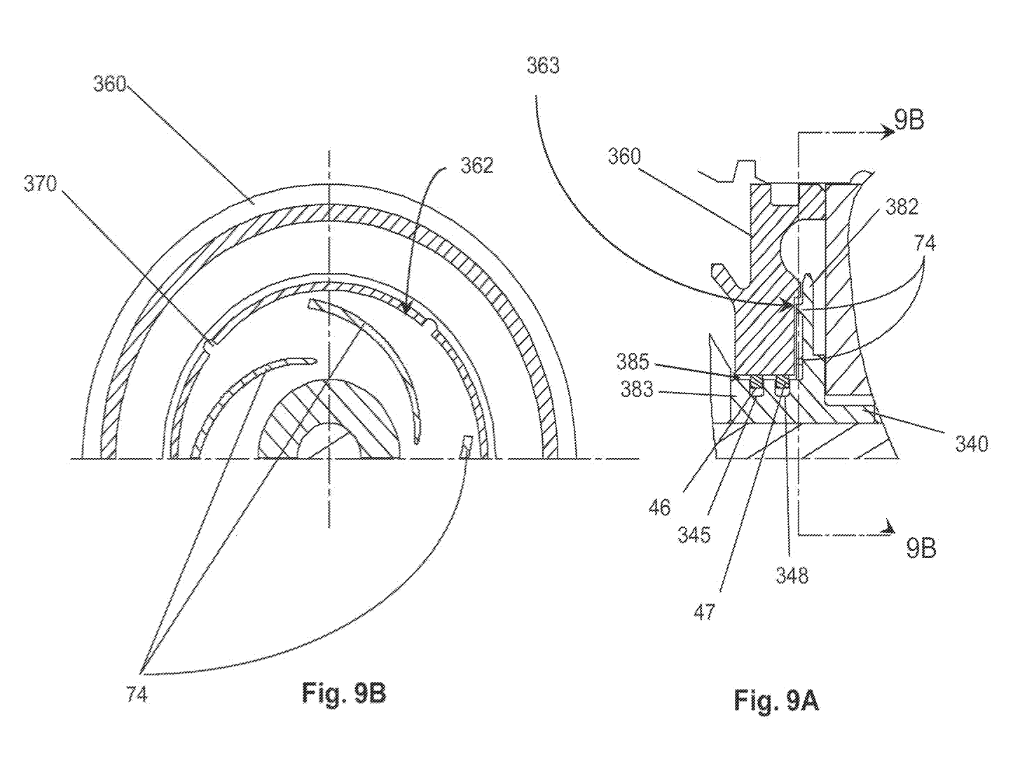

A flinger oil seal according to a third exemplary embodiment, is shown in FIGS. 8-9B, and includes a plurality of spiral vane segments 74 circumferentially spaced about flinger 340. Flinger 340 includes a flinger flange 382 and a sleeve portion 383 extending therefrom. The flinger flange 382 extends between the thrust bearing 59 and the insert 360. The sleeve portion 383 extends axially into an insert bore 385 formed through a central portion of the insert 360. The sleeve portion 383 includes a pair of grooves 345 and 348 in which are disposed mating seal rings 46 and 47.

Rotation of the flinger 340 (clockwise in FIGS. 8 and 9B) causes the leading edges 372 of the spiral vane segments 74 to divert the flow of oil, gas, or solids which have worked their way toward the seal rings (46, 47), onto the rotating spiral vane segments, which then guide the flow of said unwanted oil, gas, or solids toward the radially facing inner lip 362 of recess 363 formed in insert 360 and out of the recess via the oil discharge ports 370. An advantage of having four individual vanes, rather than the single long vane of the second embodiment of the invention, is that, while the single long vane of the second embodiment is not far from being in perfect balance (about the center of rotation of the flinger), with four equal vanes, each located radially at the same place on the flinger (albeit circumferentially at 90° spacing), the balance relationship is neutral. For example, the radial location of the leading edge 372 and the trailing edge 373 is at the same radius and of the same mass for each of the vane segments. The leading edge, or first end, 372 is located at a radius that is smaller than the trailing edge, or second end 373. It can be appreciate that the spiral vane segments 74 extend arcuately between the first and second ends 372 and 373, respectively.

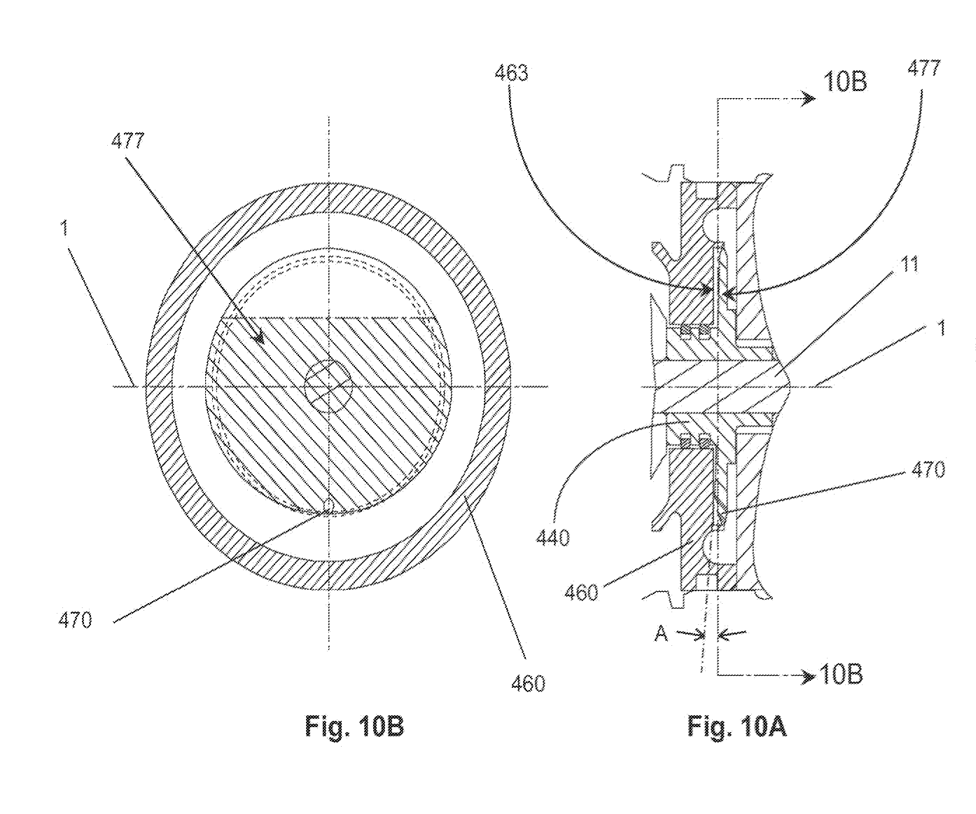

A flinger oil seal according to a fourth exemplary embodiment is depicted in FIGS. 10A and 10B. In this embodiment, an axial facing flinger surface 477 of the flinger 440 is canted at an angle A with respect to the axially facing insert recess 463 formed into insert 460. With rotation of the flinger 440, relative to the centerline l of the shaft 11 upon which the flinger 440 mounts, the angled flinger surface 477 oscillates axially thus providing a pumping action in addition to the centrifugal force acting on oil, gas, and solid matter. The cyclic local pressure generated by the pumping action acts to force unwanted matter (oil, gas, and solid matter) through a discharge port 470 thus preventing said oil, gas, and solid matter from reaching the seal rings (46, 47). This oscillating flinger surface 477 acts in a manner similar to that of a piston-free swash plate, or swash plate pump. The oscillating face can be non-flat, in which case it would be a piston-free “cam” plate.

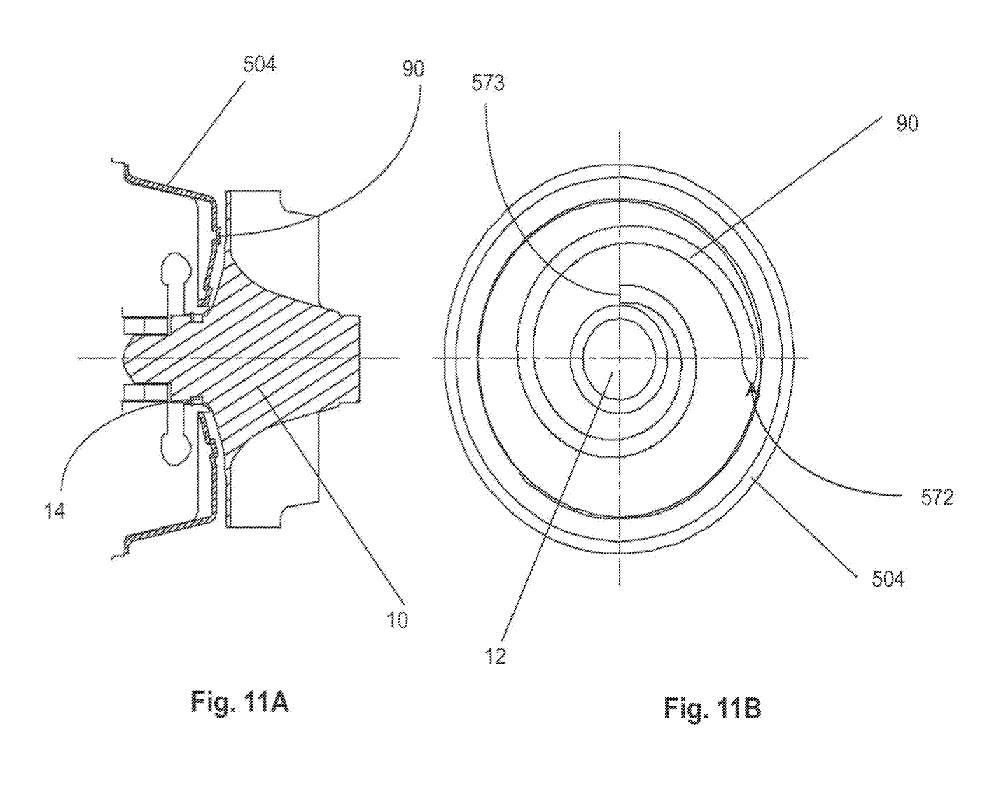

In a fifth exemplary embodiment shown in FIGS. 11A and 11B, spiral vane 90 is provided on the turbine-end heat shield 504. On the turbine-end of the turbocharger, a piston ring 14 is located in the cylindrical surface of a piston ring boss 12 located between the turbine-end of the shaft and the back face of the turbine wheel 10. In a manner opposite to that of the above embodiments, the spiral vane 90 has a leading edge 572 at a greater diameter than that of the trailing edge 573 to provide an increase in pressure towards the center of the heat shield 504 and towards the seal ring 14. While the direction of flow and pressure is different within the context of the interaction between the rotating and static elements of a matched set, the logic for having a positive pressure differential toward the inside of the bearing housing is consistent for reducing flow of oil from the bearing housing to either the compressor or turbine stages and thus, ultimately, into the exhaust system. The spiral vane 90 is pressed into the material from which the turbine heat shield is fabricated. Since most turbine heat shields are stamped using the progressive stamping process, the addition of a stamped vane is a relatively simple modification to the tool.

Accordingly, the flinger oil seal has been described with some degree of particularity directed to the exemplary embodiments. It should be appreciated; however, that the present invention is defined by the following claims construed in light of the prior art so that modifications or changes may be made to the exemplary embodiments without departing from the inventive concepts contained herein.

What is claimed is:

1. A compressor oil seal, comprising:
a thrust bearing (59) adapted for insertion into a turbocharger housing cavity (33), concentric with the turbocharger's compressor wheel shaft (11);
an insert (360) adapted for insertion into the cavity (33) adjacent the thrust bearing (59), wherein the thrust bearing (59) and insert (360) are configured to provide an oil drain cavity (35) therebetween;
an oil flinger (340) including a flinger flange (382) and a sleeve portion (383) extending therefrom, wherein the flinger flange (382) extends between the thrust bearing (59) and the insert (360), and wherein the sleeve portion (383) extends axially into an insert bore (385) formed through a central portion of the insert (360); and
a plurality of spiral vane segments (74) circumferentially spaced about the flinger flange (382).

2. The compressor oil seal according to claim 1, wherein the spiral vane segments (74) are disposed between the flinger flange (382) and the insert (360).

3. The compressor oil seal according to claim 1, wherein the spiral vane segments (74) extend into a recess (363) formed into the insert (360).

4. The compressor oil seal according to claim 3, wherein the recess (363) includes at least one discharge port (370).

5. The compressor oil seal according to claim 1, wherein each spiral vane segment (74) extends arcuately from a first end (372) to a second end (373).

6. A turbocharger, comprising:
a compressor wheel (32) and a turbine wheel (10) mounted on opposite ends of a shaft (11);
a housing (20) supporting the shaft (11) and including a cavity (33) formed adjacent the compressor wheel (32);
a thrust bearing (59) disposed in the cavity (33);
an insert (360) disposed in the cavity (33) and adjacent the thrust bearing (59); and
an oil flinger (340) including a flinger flange (382) and a sleeve portion (383) extending therefrom, wherein the flinger flange (382) extends between the thrust bearing (59) and the insert (360), and wherein the sleeve portion (383) extends axially into an insert bore (385) formed through a central portion of the insert (360); and
a plurality of spiral vane segments (74) circumferentially spaced about the flinger flange (382) and disposed on an axially facing surface of the flinger flange (382).

7. The turbocharger according to claim 6, wherein the spiral vane segments (74) are located between the flinger flange (382) and the thrust bearing (59).

8. The turbocharger according to claim 6, wherein the spiral vane segments (74) are located between the flinger flange (382) and the insert (360).

9. The turbocharger according to claim 6, wherein the spiral vane segments (74) extend into a recess (363) formed into the insert (360).

10. The turbocharger according to claim 9, wherein the recess (363) includes at least one discharge port (370).

11. The turbocharger according to claim 6, wherein each spiral vane segment (74) extends arcuately from a first end (372) to a second end (373).

12. The turbocharger according to claim 11, wherein the first end (372) is located at a radius on the flinger flange (382) that is smaller than a radius at which the second end (373) is located.

13. The turbocharger according to claim 6, further comprising a seal ring (46, 47) disposed in a groove (345, 348) formed around the sleeve portion (383).

14. A turbocharger, comprising:
a compressor wheel (32) and a turbine wheel (10) mounted on opposite ends of a shaft (11);
a housing (20) supporting the shaft (11) and including a cavity (33) formed adjacent the compressor wheel (32);
a thrust bearing (59) disposed in the cavity (33);
an insert (360) disposed in the cavity (33) and adjacent the thrust bearing (59);
an oil flinger (340) including a flinger flange (382) and a sleeve portion (383) extending therefrom, wherein the flinger flange (382) extends between the thrust bearing (59) and the insert (360), and wherein the sleeve portion (383) includes a groove (345, 348) and extends axially into an insert bore (385) formed through a central portion of the insert (360);
a seal ring (46, 47) disposed in the groove (345, 348); and
a plurality of spiral vane segments (74) circumferentially spaced about the flinger flange (382) and disposed on an axially facing surface of the flinger flange (382), wherein each spiral vane segment (74) extends arcuately from a first end (372) located at a first radius on the flinger flange (382), to a second end (373) located at a second radius on the flinger flange (382) that is larger than the first radius.

15. The turbocharger according to claim 14, wherein the spiral vane segments (74) are located between the flinger flange (382) and the insert (360).
